(19) United States
(12) Patent Application Publication
(10) Pub. No.: US 2009/0185188 A1
(43) Pub. Date: Jul. 23, 2009

(54) PASS-FAIL TOOL FOR TESTING PARTICULATE CONTAMINATION LEVEL IN A FLUID

(75) Inventors: Barry Verdegan, Stoughton, WI (US); Brian Clary, Madison, WI (US); Molly Debilzen, Oregon, WI (US); Daniel Cady, Janesville, WI (US)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP, INC., Minneapolis, MN (US)

(21) Appl. No.: 12/017,447

(22) Filed: Jan. 22, 2008

(51) Int. Cl. G01N 21/00

(52) U.S. Cl. 356/442; 356/337

(57) ABSTRACT

A simple pass-fail tool that can be used to test the particulate contamination level in a fluid. The tool relies upon a comparison between a measured indicator of the contamination level in the fluid with another indicator of a contamination level of the fluid. Based on the comparison, conclusions about the contamination level of the fluid, and decisions about the fluid, for example that the fluid is acceptable for a particular use, can be made. The fluid can be fuel, lubrication, power transfer, heat exchange or other fluids used in a fluid system, for example fuel injection systems of diesel engines or hydraulic systems, where contamination of the fluid is of concern and use of an excessively contaminated fluid is to be avoided.

### FIELD

This disclosure relates to testing and monitoring of fluids where particulate contamination is of concern, and where it is important to know whether the fluid is acceptable for a particular use. More particularly, this description relates to testing the particulate contamination level in a fluid which can be used to, for example, determine the acceptability of the fluid for use, for example a fluid for fuel, lubrication, power transfer, heat exchange or other fluids in fluid systems, where contamination is of concern.

### BACKGROUND

In systems that utilize fluid for fuel, lubrication, transfer of power, and/or heat exchange, it is important that minimum levels of cleanliness be maintained. Contamination in the fluids may be the result of any combination of undesirable solid particles and immiscible water or other fluid droplets in a fluid. Solids and droplets in the fluid can damage system components, shorten life, and reduce performance. An example of a contamination sensitive system is a high pressure common rail (HPCR) fuel injection system for a diesel engine.

In the past, to determine whether a fluid is acceptable for a particular use, the fluid was sent to a laboratory for analysis or a portable particle counter was used. However, sending fluid samples to a laboratory for analysis can take days to learn the results. Portable particle counters are relatively expensive and tend to provide too much data to an unsophisticated user. Further, existing particle counters used for analysis on petroleum-based fluid, e.g. fuel, lubricating oil, and hydraulic oil, are not capable of counting particles smaller than about 3 μm(c).

### SUMMARY

A simple pass-fail tool is described that can be used to test a fluid for particulate contamination level, which can provide a relatively quick determination whether or not a fluid is suitable for a particular use with regard to particulate contamination in the fluid. The fluid can be a fuel such as diesel fuel (including biodiesel) or gasoline; lubrication, power transfer, heat exchange, water or other fluids used in a fluid system, for example fuel injection systems of diesel engines or hydraulic systems, where contamination of the fluid is of concern and use of an excessively contaminated fluid is to be avoided.

The pass-fail tool described herein allows equipment operators to quickly determine whether or not the fluid is acceptable for use prior to exposing the equipment to excessively contaminated fluid that may cause damage. In many cases, the only information needed is whether or not a fluid meets a minimum cleanliness level required for use in the particular application. It is often not necessary to know the precise contaminant concentration; rather, it is sufficient to know that the fluid is “clean enough” or acceptable for a given application. For example, in HPCR diesel fuel applications, the Worldwide Fuels Charter currently calls for fuel to have a cleanliness level of International Organization for Standardization (ISO) 4406 Solid Contamination code of 18/16/13 or cleaner, and water concentrations below 200 ppm.

The pass-fail tool alerts the operator to the presence of potentially harmful levels of contamination in the fluid, or conversely provides the operator a level of comfort that the fluid is acceptable for use with regards to contamination. Since contamination levels can vary over time and circumstances, the pass-fail tool allows an operator to be able to determine whether the fluid is sufficiently clean on one-time basis, a periodic basis, or on a continuous basis.

The pass-fail tool relies on the theory that the amount of light scattered or absorbed, i.e. the turbidity, by a sample is directly related to contamination levels. Once the contamination level of the sample is known, appropriate action can be taken. For example, turbidity can be related to the 4 μm(c) size digit of ISO Code.

In one embodiment, a method of testing the particulate contamination level of a fluid includes directing a light beam into a sample chamber containing a sample of the fluid, and detecting the amount of light scattered or absorbed by the fluid sample. A signal having a magnitude that corresponds to the amount of scattered or absorbed light is compared with another indicator of a contamination level of the fluid.

The indicator can be any indicator (actual or theoretical) that indicates a contamination level of the fluid against which someone may want to compare the signal. For example, the indicator can be a predetermined contamination level, a historical indicator of a contamination level such as a prior generated signal, or a mathematically derived indicator of a contamination level. Therefore, the tool can be used to make a number of determinations regarding the fluid, for example the acceptability of the fluid for use, or that conditions in the fluid are changing for better or for worse.

Turbidity can be considered to be a measure of a liquid's clarity or cloudiness due to the presence of solids, particles, droplets and other undissolved species. Turbidity can be measured by a nephelometer which is an instrument that measures the amount of light scattered or absorbed by a sample. The relationship between the light scattered under defined conditions and turbidity is established by comparison of the light scattered by samples of known turbidity. Standard Methods for the Examination of Water and Wastewater, 14th edition, 1975, M. C. Rand, Arnold E. Greenberg, Michael J. Taras, and Mary Ann Franson, editors, APHA-AWWA-WPCF, pp. 131-134.

This description primarily uses terms like “scattering”, “scattered”, “light scattered” and the like. Instead of detecting the amount of light scattered, an acceptable alternative would be to detect the amount of light absorbed by the sample. Once one corrects for baseline absorption by the fluid sample itself, detecting the amount of light absorbed is essentially a measure of forward scattering. Therefore, it is to be understood that the pass-fail tool described herein can utilize either or both of light scattering and light absorption, or other measures indicative of the amount of interaction between the incoming light beam and particulate contaminants in the sample.

The predetermined contamination level or threshold can be based on a measurement of a reference sample or condition. The measurement can be performed visually by conducting a side-by-side comparison between the sample being tested and a reference sample. The measurement can also be performed automatically using a sensor that generates a voltage signal the magnitude of which is related to the amount of light detected, that is then compared to the threshold which is a stored voltage value.

In another embodiment, a method of testing the particulate contamination level of fuel is provided. The method includes directing a light beam into a sample of the fuel, and detecting the amount of light scattered or absorbed by the fuel sample. The amount of scattered or absorbed light is compared with at least one predetermined threshold, each threshold corresponding to a respective known turbidity condition of the fuel. If the detected amount of scattered or absorbed light exceeds the predetermined threshold, the fuel is determined to be unacceptable for use.

A method is also described that includes establishing a first turbidity threshold level corresponding to a maximum permissible concentration of particulate contamination in a fluid for use in comparison with a signal that corresponds to the amount of light scattered or absorbed by a sample of the fluid as a result of directing a light beam into the fluid sample. A second turbidity threshold level can also be established corresponding to a maximum permissible contaminant water concentration in the fluid. The lower of the first turbidity threshold level or the second turbidity threshold level can be selected as a predetermined threshold level for use in comparison with a detected amount of light scattered or absorbed by a fluid sample.

The pass-fail tool also includes a system for testing the particulate contamination level of a fluid. The system includes a sample chamber suitable for containing a sample of the fluid, the sample chamber permitting light to impinge on the fluid sample and permitting light to exit the sample chamber. A light source directs light into the sample chamber, and a detector detects light scattered or absorbed by the fluid sample and generates a signal whose magnitude is related to the amount of scattered or absorbed light detected. A processing unit receives the signal from the detector, compares the received signal with a reference indicator of a contamination level of the fluid, and creates an output signal based on the comparison of the received signal with the reference indicator.

### DESCRIPTION OF THE DRAWINGS

FIG. 1 is a diagram of a pass-fail process for determining whether a fluid is acceptable for a particular use.

FIGS. 2A-C illustrate examples of fluid samples being tested in a pass-fail system.

FIGS. 3A-3C illustrate additional examples of a pass-fail system.

### DETAILED DESCRIPTION

A pass-fail tool is described that includes methods and systems used to determine whether a fluid is acceptable for a particular use with regards to particulate contamination in the fluid. For example, the pass-fail tool can be used to determine whether or not a fluid is excessively contaminated before the fluid is used in a particular application. The description will hereinafter describe the fluid as being fuel, particularly diesel fuel (including biodiesel), used with a HPCR fuel injection system. However, the concepts described herein can be applied to other types of fluids including, but not limited to, other fuels such as gasoline, hydraulic fluids and other fluids where contamination of the fluid is of concern.

Fuel contamination level is defined herein as the concentration of solid particles, semi-solids, and immiscible droplets, typically water, in the fuel. The acceptability of the fuel is determined by using a predetermined threshold corresponding to a known turbidity condition of the fuel. Turbidity is a measure of the clarity of a fluid. In general, the higher the turbidity, the higher the contamination level in the fuel and the dirtier it is. Turbidity is a function of the size and concentration of particulates within a sample fluid as well as the optical characteristics of the fluid and particulates. Particulates as used herein including the claims include all solid, semi-solid, droplets and other immiscible particles. As opposed to particle counting, turbidity is based on light interactions with a population of particles and not with a single particle. Since turbidity is a function of particle size distribution and number, and since the number concentration of particles larger than a certain size increases approximately exponentially with decreasing size, the pass-fail tool described herein is especially sensitive to fine particles, including those below 3-4 μm(c) that are too small to detect by particle counting in oil and fuel but are believed to cause significant damage to HPCR fuel injectors. Thus, the pass-fail tool provides a tool for monitoring concentration of very fine, otherwise undetectable but harmful particles.

The inventors have discovered that in the field there is a correlation between turbidity and particle counts and/or water concentration. In general the amount of scattered or absorbed light caused by directing a light beam into a fuel sample correlates to the turbidity of the fuel and the higher the turbidity, the higher the likelihood that the fuel sample is unacceptable for use. This semi-quantitative relationship between contamination levels and turbidity can be used for determining whether a fuel or other fluid sample is acceptable for a particular use.

For sake of facilitating this description, the pass-fail tool will be described as using light scattering, detecting the amount of light scattered, and the like. It is to be understood that the pass-fail tool described herein can also utilize other measures that are indicative of the amount of interaction between the light beam and particles in the fuel sample, for example the amount of light absorbed by the fuel sample.

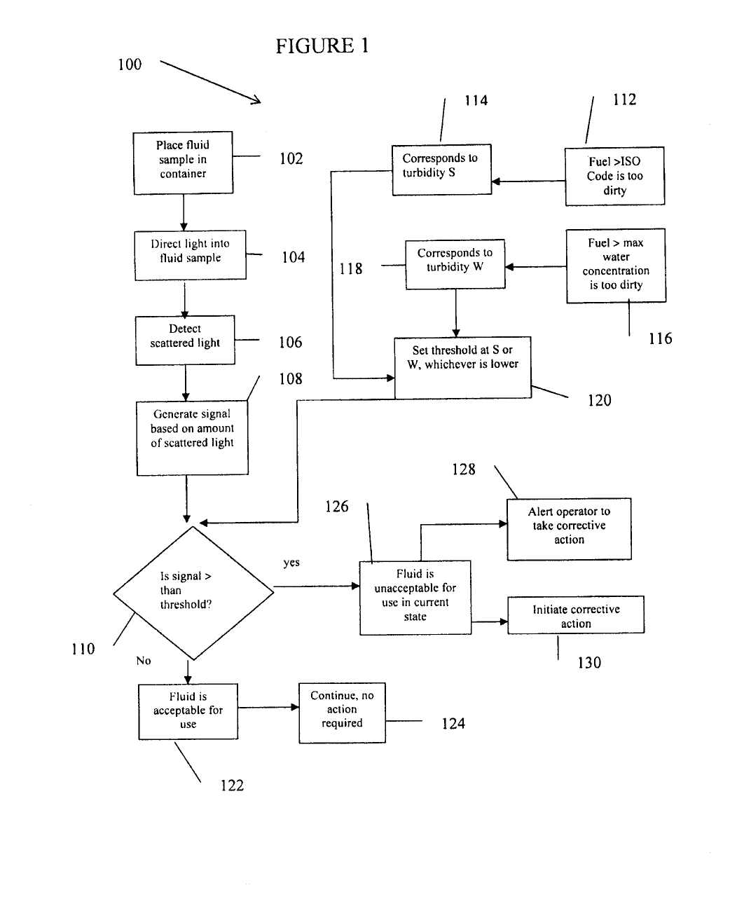

FIG. 1 is a diagram of a pass-fail process 100 for determining whether a fuel is acceptable for use. The process 100 includes introducing 102 a fluid sample into a sample chamber, followed by directing 104 a light beam into the fuel sample. The sample chamber may be a batch container for holding and analyzing static fuel samples in discrete batches or a flow-through chamber for continuous analysis of a flowing fuel sample as the fuel sample passes through the flow-through chamber. Typically, the volume of the sample illuminated by the light source is large relative to the average volume of fuel occupied by a single particle of the solid or droplet fluid contaminant in order to ensure that the a representative sample of the entire population of particles is sampled. For example, if there is a concentration of 10⁶ particles/mL, the average volume per particle is 10⁻⁶ mL/particle. In this case, the sample volume should be 10⁻³ mL or larger.

The light beam is directed into a transparent portion of the sample chamber and into the sample fuel being analyzed. The light beam can be either monochromatic, such as a light beam emitted from a laser diode, or polychromatic, such as a light beam directed from a white light source. The path length of the light beam through the fuel sample must be great enough that the population of contaminants is accurately represented, but short enough such that scattered light reaches a detector.

At 106, the amount of light scattered by the fuel sample is detected by a detector. At 108, the detector generates a signal having a magnitude based on the amount of scattered light, and sends the signal to a processing device. In some embodiments, the amount of light scattered by the fuel sample is detected automatically, for example using a photodetector. In other embodiments, the amount of light scattered by the fluid sample is detected manually, for example the human eye. The detector can be located at any angle relative to the light beam, as long as it is able to detect scattered light. For example, the detector can be positioned at an angle of incidence a between 0 and 180° from the light beam, or at an angle of incidence between 45 and 135°.

At 110, the signal from the photodetector is then compared to at least one predetermined reference threshold corresponding to a respective known or reference critical turbidity condition using the processing unit. One way to establish the threshold is to relate the turbidity of the fluid sample, as represented by the signal generated by the detector, to one or more contamination levels. The contamination levels can be based on desired cleanliness levels for the fuel. For example, as illustrated in FIG. 1 at 112, one cleanliness level can correspond to a maximum permissible concentration of solid or semi-solid particles in the fuel as established by an ISO Code, such as ISO Code 18/16/13. If the fuel exceeds the ISO Code, the fuel is considered to be too dirty, and at 114 that cleanliness level is considered to correspond to a turbidity S. Another cleanliness level can be established at 116 by establishing a maximum desired water concentration for the fuel, for example 200 ppm, and if the fuel exceeds that concentration, the fuel is considered to be too dirty, and at 118 that cleanliness level is considered to correspond to a turbidity W. At 120, the threshold is set at the lower of S or W, thereby establishing the turbidity level above which the fuel is considered to be too dirty. It is not necessary to determine both thresholds. The threshold level could be determined using only the ISO Code, the particulate concentration level, or water concentration level.

The critical turbidity and corresponding critical threshold above which the fuel is considered unacceptable can be determined in a number of other ways. In one example, a predetermined threshold corresponding to a known turbidity condition is determined based on the lowest turbidity failing to meet the necessary fluid cleanliness levels observed from reference samples. Reference samples can comprise a variety of samples of differing particle and water contaminant concentrations with differing particle size distributions for which turbidity and particle counts and/or water concentration data have been obtained. In use, when the fuel exhibits a turbidity that exceeds this threshold, it is considered as being unacceptable for use. This provides a conservative estimate of fuel acceptability, as some fuel with excessive turbidity that fail the test may actually be acceptable based on actual particle count or water concentration data. In critical applications where it is of paramount importance to keep equipment running reliably, this conservative method of assessing fuel acceptability ensures that clean fuel will be used, increasing equipment/engine life, reliability and robustness.

The critical threshold can also be established based on knowledge of the application for which the fuel is to be used. In general, there are similarities among particle size distributions for similar types of samples. For example, supply tank fuel from different locations and times tend to have a wide range of contaminant concentrations, but similar particle size distributions. The same can be said for samples collected downstream of a filter. This observation can be used to establish the critical threshold. Samples with particle size distributions similar to that anticipated for a given application can be made up at differing concentrations, and the turbidity and particles counts and/or water concentrations measured. From this data, the lowest turbidity at which the fuel first becomes unacceptable is defined as the critical turbidity or threshold.

For example, for biodiesel supply fuel samples, samples of ISO Medium Test Dust and water in fuel with an interfacial tension of approximately 15 dyne/cm may be used to establish the critical threshold. ISO UltraFine Test Dust may be used when samples are measured downstream of secondary filters.

At 110, the processing unit compares the signal generated by the detector with the threshold set at 120. A signal value corresponding to a turbidity higher than the critical turbidity obtained for the fluid is considered unacceptable for the particular use. In some embodiments, including embodiments where the amount of scattered light is detected automatically, the processing unit is a signal processor. In other embodiments, including embodiments where the amount of scattered light is detected visually by the human eye, the processing unit is the human mind.

If the value of the signal from the detector is less than the predetermined threshold, the processing unit at 122 sends an output signal to an output unit indicating that the fluid sample is acceptable for use and at 124 use of the fuel can continue with no action required. The output unit can communicate the result to the operator, equipment and/or engine.

If the value of the signal exceeds the predetermined threshold, the processing unit at 126 sends an output signal to the output unit indicating that the fluid sample is unacceptable for use in its current state. At 128, the output unit then alerts the operator to take appropriate corrective action, or at 130, automatically initiates corrective action. For example, in some embodiments, corrective action can include alerting the operator to replace the fuel from which the fuel sample was obtained, altering the equipment using the fuel to compensate for the loss in fuel cleanliness, or alerting the operator to replace the filters with new or different filters. The operator can be provided a list of possible options for corrective action as well as a recommended corrective action. When the output unit is coupled to a digital signal processor, notification to the operator can be accomplished, for example, via a display light, an error message, an audible warning or other notification methods.

In addition, a color or other indication system can be adopted to alert the operator. For example, if the value of the signal is below the lowest of S or W, the color green can be lit indicating that the fluid is acceptable; between S and W the color yellow can be lit indicating a warning to the user that the fluid may need further or more detailed monitoring; and above the highest of S or W the color red can be lit indicating that immediate action is required.

In some embodiments, for example where the sample chamber is a flow-through chamber, the processing unit can also monitor the value of the signal from the detector over a period of time and calculate a rate of change in the value of the signal, which corresponds to a change in the turbidity of the fuel. The processing unit compares the rate of change of the signal, corresponding to the change in turbidity, with a stored critical rate of change. If the rate of change is below the stored critical rate of change, the processing unit sends an output signal to the output unit indicating that the fluid sample is acceptable for use. If the rate of change exceeds the stored critical rate of change, the processing unit sends an output signal to the output unit indicating that the sample fluid is unacceptable due to the deteriorating conditions of the sample fluid. The output unit can also be used to indicate that contamination levels are changing.

A pass-fail system for determining whether a fluid is acceptable for use includes a light source, a fluid sample holder, a detector for detecting scattered light, a signal processor, and an output. As indicated above, the light source can be monochromatic, for example a laser diode, or polychromatic, for example a white light source.

The fluid sample holder can be any container for static or flow-through fluid samples that has windows or walls transparent to the incident light and to scattered light emerging from the fluid sample.

The detector can be an electrical detector, for example a photodetector, or the human eye. If the detector is a photodetector, the photodetector generates an electrical signal whose magnitude is related to the amount of scattered light detected, and thus related to the turbidity of the fluid. The detector, whether a photodetector or human eye, can be located at an angle of incidence to the incoming light beam from the light source between 0 and 180 degrees, or between 45 and 135 degrees.

The signal processor can be a digital signal processor or the human mind. The signal processor takes the signal output from the detector and compares it to one or more reference or threshold values corresponding to known reference turbidity conditions. The reference conditions can be actual reference samples, visual representations of reference conditions, or predetermined reference conditions stored in the signal processor. Based on the result of the comparison(s), a determination is made whether or not the cleanliness level of the fluid is acceptable for a particular use.

The signal processor outputs the result(s) of the determination to the output unit that communicates the result(s) to the operator, equipment or engine in a manner that allows action to be taken. The output can be the human body or a form of indicator such as a light or an audible alarm device.

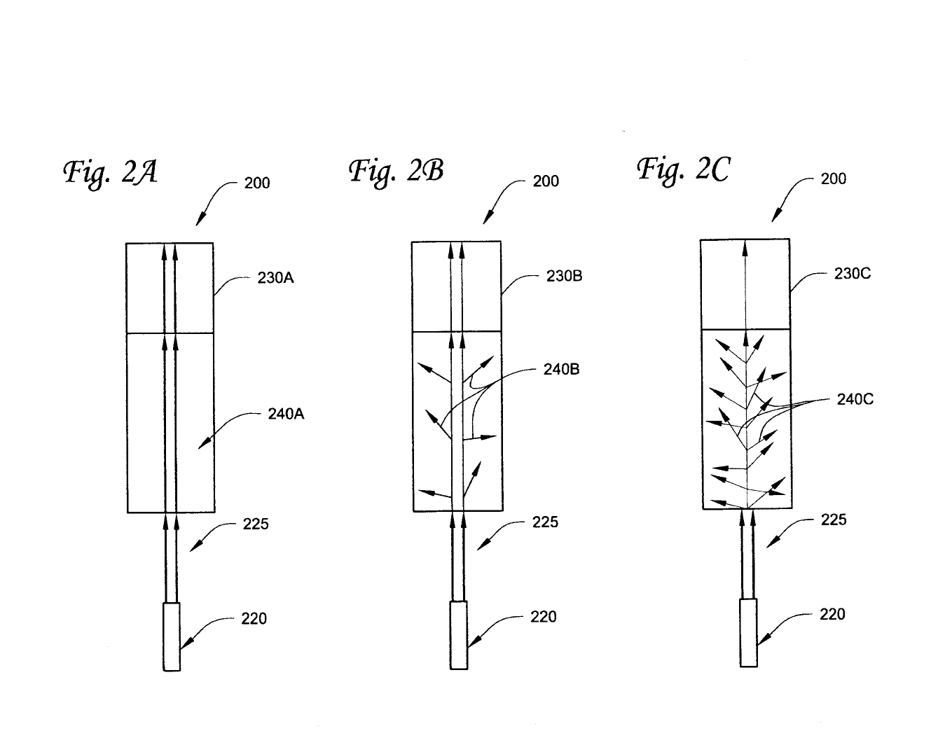

FIGS. 2A-C illustrate examples of one pass-fail system 200 to determine whether a fluid is acceptable for use. A monochromatic laser pointer 220 is used as a light source to direct a light beam 225 into glass containers 230A-C that hold MIL-H-5606 hydraulic oil contaminated with different amounts of ISO UltraFine test dust. Reference numerals 240A-C indicate the scattered light. Visually, the operator can discern differences in turbidity among the three samples and, by comparison to reference samples, estimate whether a particular sample is above or below a critical cleanliness level, for example a 4 μm(c) ISO Code of 18. Using this exemplary cleanliness level, the container 230A having a corresponding ISO Code of about 17 is considered acceptable, while containers 230B and 230C with corresponding ISO Codes of about 21 and 25, respectively, are not considered acceptable.

The system in FIGS. 2A-C is a manual system in which the operator doing the testing or another human performs the functions of visually detecting the amount of scattered light, processing the information regarding the amount of scattered light, deciding whether the amount of scattered light is excessive to indicate excessive contamination, and acting as the output unit to take appropriate action. The laser pointer 220 is positioned so as to direct the light beam 225 directly into the containers 230A-C.

The container 230A-C in this exemplary embodiment are formed entirely of transparent material, for example glass. However, in other embodiments the containers 230A-C can be formed with transparent windows located only at portions of the container that are incident to the light beam of the laser pointer 220 and to the light that is scattered by contaminants in the fluid being tested. In this embodiment, the containers 230A-C hold static fluid samples.

The operator or other human visually monitors the scattered light from the fluid sample. The operator then compares the amount of scattered light to one or more reference thresholds, for example visual charts or thresholds stored in the operator's brain representing known turbidity conditions. The operator then estimates whether the amount of scattered light is above or below the reference thresholds and decides whether the fluid is unacceptably contaminated. If the operator determines that the fluid is not acceptable, the operator can take corrective action or begin implementing corrective action. Corrective action may include, for example, replacing the fluid from which the fluid sample was obtained, altering the equipment using the fluid to compensate for the loss in fluid cleanliness, or replacing filters with new or different filters.

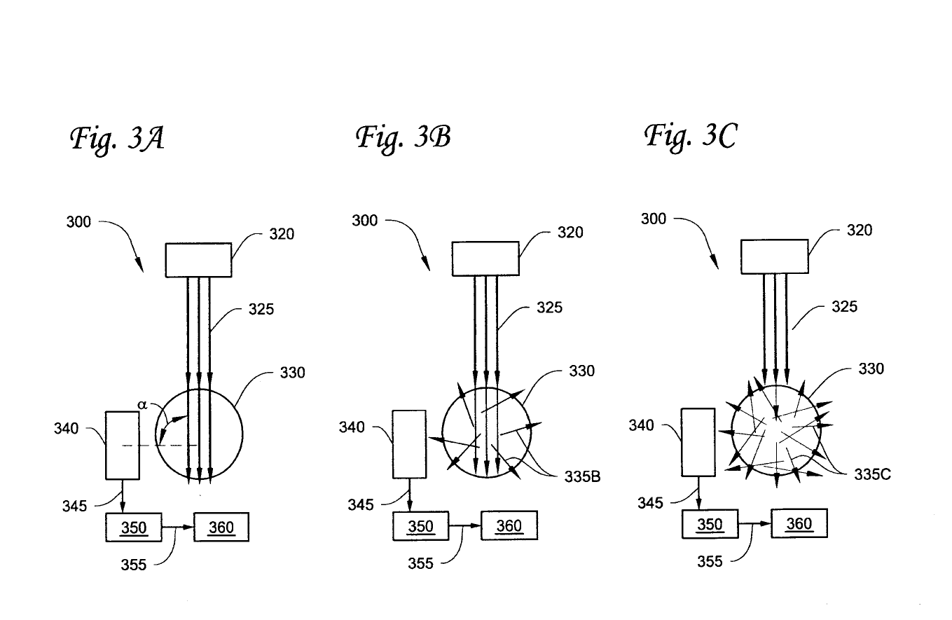

FIGS. 3A-3C illustrate examples of an automated pass-fail system 300. The automated pass-fail system 300 includes a light source 320, a sample chamber 330 containing a fluid sample, and a photodetector 340 that is coupled to a signal processor 350 which in turn is coupled to an output unit 360. The light source 320 is positioned so as to direct a light beam 325 directly into the sample chamber 330.

The sample chamber 330 can be either a container for holding and analyzing a static fluid sample, or the chamber can be flow-through chamber where fluid continuously flows through the chamber. The photodetector 340, which is disposed at a suitable angle of incidence a to the incoming light from the light source 320, monitors light scattered 335B, 335C by the fluid sample in the sample chamber 330 and generates a signal whose magnitude is related to the amount of scattered light detected. The signal 345 is sent to the signal processor 350 which compares the received signal to one or more stored reference thresholds representative of known turbidity conditions. In some embodiments the reference threshold can be a single threshold that corresponds to the minimum acceptable ISO code. Also, in some embodiments, a plurality of reference thresholds can be stored in the signal processor 350 that allows the output signal 345 to be compared to the plurality of thresholds. Moreover, in some embodiments, where the sample chamber 330 is a flow-through chamber, the signal processor 350 monitors the fluid in the chamber 330 over a period of time and calculates a rate of change in the signal from the photodetector, representing changes in the scattered light. If the rate of change exceeds a stored critical rate of change, an output signal can be generated to instruct the output unit 360 to notify the user of deteriorating conditions of the sample fluid. The deteriorating conditions can be caused in a number of ways, for example by a failure of a filter or by externally induced contamination.

The output unit 360 performs an action based on the output signal 355. If the signal processor 350 determines that the scattered light signal 345 does not exceed a predetermined reference threshold, the fluid is considered acceptable and the output signal 355 instructs the output unit 360 that no action is necessary. If the signal processor 350 determines that the scattered light signal 345 does exceed the predetermined reference threshold, the fluid is not considered acceptable and the output signal 355 instructs the output unit 360 to notify the user that it is not acceptable. Notification can be made, for example, via a display light, an error message or an audible warning.

The pass-fail systems 200, 300 can have a number of different configurations, for example as an on-vehicle system, a probe, a portable unit intended for use outside of a testing lab, a unit intended for use inside of a testing lab, and other configurations. The systems 200, 300 can take any form, as long as they provide an easy to use tool for service personnel, engine operators and others in the field.

1. A method of testing the particulate contamination level in a fluid, comprising:
directing a light beam into a sample chamber containing the fluid;
measuring the turbidity of the fluid sample by detecting the amount of light scattered by the fluid sample that exits the sample chamber;
generating a signal having a magnitude that corresponds to the amount of scattered light that is detected; and
comparing the generated signal to another indicator of a contamination level of the fluid.

2. The method of claim 1, wherein the fluid is fuel or hydraulic fluid.

3. The method of claim 1, wherein the another indicator of a contamination level is a predetermined contamination level, a historical indicator of a contamination level, or a mathematically derived indicator of a contamination level.

4. The method of claim 1, wherein the another indicator of a contamination level is the predetermined contamination level, and the predetermined contamination level corresponds to a maximum permissible concentration of solid, semi-solid, droplet and/or immiscible particles in the fluid.

5. The method of claim 4, wherein at least some of the particles are of a size 4 μm(c) or less.

6. The method of claim 1, further comprising:
determining whether or not the fluid is acceptable for a particular use based on the comparison; and
prompting the user to take corrective action if the fluid is determined not to be acceptable for use.

7. The method of claim 1, further comprising:
determining a rate of change of the generated signal; and
comparing the determined rate of change with a predetermined critical rate of change.

8. The method of claim 7, comprising generating an alert if the determined rate of change exceeds the predetermined critical rate of change.

9. A method of testing the particulate contamination level in fuel, comprising:
directing a light beam into a sample chamber containing the fuel;
detecting the amount of light scattered by the fuel sample that exits the sample chamber and generating a signal based on the detected amount of scattered light; and
comparing the generated signal with at least one predetermined threshold, each threshold corresponding to a respective known turbidity condition of the fuel.

10. The method of claim 9, wherein the fuel is diesel fuel.

11. The method of claim 9, wherein the at least one predetermined threshold corresponds to an ISO Code.

12. The method of claim 9, wherein the particulate contamination comprises at least some particles having a size 4 μm(c) or less.

13. The method of claim 9, wherein the at least one predetermined threshold corresponds to a maximum water concentration level.

14. The method of claim 9, wherein the fuel sample is static or flowing.

15. The method of claim 9, further comprising determining that the fuel is not acceptable for use with regards to particulate contamination if the generated signal exceeds the at least one predetermined threshold, and generating an alert based on the determination.

16. The method of claim 9, further comprising:
determining a rate of change of the generated signal;
comparing the determined rate of change with a predetermined critical rate of change.

17. The method of claim 16, comprising generating an alert if the determined rate of change exceeds the predetermined critical rate of change.

18. A method, comprising:
establishing a first turbidity threshold level corresponding to a maximum permissible concentration of particulate contamination in a fluid for use in comparison with a signal that corresponds to the amount of light scattered by a sample of the fluid contained in a sample chamber as a result of directing a light beam into the sample chamber containing the fluid sample.

19. The method of claim 18, comprising comparing the signal with the first turbidity threshold level.

20. The method of claim 18, wherein the first turbidity threshold corresponds to an ISO Code, and comprising establishing a second turbidity threshold level corresponding to a maximum permissible water concentration in the fluid, and selecting the lower of the first turbidity threshold level or the second turbidity threshold level as a predetermined threshold level for use in comparison with the signal.

21. A system for testing the particulate contamination level of a fluid, comprising:
a sample chamber suitable for containing a sample of the fluid, the sample chamber permitting light to impinge on the fluid sample and permitting light to exit the sample chamber;
a light source for directing light into the sample chamber;
a detector exterior of the sample chamber that detects light scattered by the fluid sample and generates a signal whose magnitude is related to the amount of scattered light detected; and
a processing unit that receives the signal from the detector, compares the received signal with a reference indicator of a contamination level of the fluid, and creates an output signal based on the comparison of the received signal with the reference indicator.

22. The system of claim 21, further comprising an output unit that receives the output signal from the processing unit and provides a notification.

23. The system of claim 21, wherein the sample chamber is a flow-through chamber or a static chamber.

24. The system of claim 21, wherein the light from the light source is monochromatic or polychromatic.

25. The system of claim 21, wherein the detector is a photodetector and the processing unit is a signal processor.

26. The system of claim 21, wherein the processing unit generates a first output signal when the received signal is equal to or greater than the reference indicator, and generates a second output signal when the received signal is less than the reference indicator.
